(19) United States
(12) Patent Application Publication
(10) Pub. No.: US 2004/0025141 A1
(43) Pub. Date: Feb. 5, 2004

(54) Vectoreyes web-viewer

(75) Inventors: Rajan Parkash Nanda, Boston, MA (US); Lars Matsson, Concord, MA (US); Rushikesh Ratnakar Bandekar, Mumbai (IN); Deepak Temkar, Mumbai (IN); Maharshi Desai, Mumbai (IN)

Correspondence Address: LARS MATSSON, 280 SILVER HILL ROAD, CONCORD, MA, 01742, US

(73) Assignee: Full Circle Technologies, Inc.

(21) Appl. No.: 10/212,021

(22) Filed: Aug. 5, 2002

(51) Int. Cl. G06F 9/44

(52) U.S. Cl. 717/100

(57) ABSTRACT

NATURE OF INVENTION: A Computer software for “managing” data files located on a server over the Internet, intranet or any network without using any plug-in. The Data files may be CAD files, GIS files, Database files, Document files, Image files or any other category required to be supported.

STRUCTURE: The software program consists of code written in Java, ASP, XML, Java Script, VB, VB Script, Html, Dhtml, CGI pearl or other format. The code files may work collectively as single application or small multiple independent modules performing specialized tasks of file management.

PURPOSE: Viewing, creating, editing, analyzing (Querying), printing and hosting the shared data, like drawings and maps, accessible from multiple remote locations independently and simultaneously using a computer connected to Network, which have the access to server containing VectorEyes files.

### BACKGROUND

1. Field of Invention

This invention relates to display, distribution, modification, editing and management of drawings, documents, maps, images and data located at centralized locations directly from any remote location.

2. Description of Prior Art

From times immemorial, humans have attempted to device means of dissemination of information to others in the short possible time with the highest accuracy.

Parchment gave way to paper, which after holding its own for a long time is slowly giving way to the computer. With the appearance of seamless connectivity across space of computers, the need for physically transferring information by means of tangible media is reducing. By optimum use of a combination of appropriate hardware and software, it is now possible to have information required by large numbers of people stored at a central location (here after referred as “server”) with all users having the ability to view or modify the information from their own location (here after referred as “client”) without having to physically transfer pieces of paper or plastic across space.

Other inventors have created different methods of viewing or modifying information residing on central servers, but several of these involve the use of packages and computer programs that need to be installed on either the server or the client side computer. Although these programs do aid in the retrieval and modification of information, these programs all need to be specifically downloaded (or copied on the client machine through CD, floppy, or any other media), and installed on the user's machine and only then can the program be used for the required purpose.

Since the installable packages are installed on the user's machine, it is difficult and cumbersome to seamlessly modify data stored at the central location with the installable packages, a major proportion of which in fact allow only viewing. In addition, an increasing number of users are becoming increasingly cautious about downloading ANY application or computer program from the WorldWideWeb (“web”). The reasons for this are many. However some of the more significant concerns are:

the risk of downloading a malicious virus along with the program, which could potentially disable the user's machine, or entire network,

the fact that the user has to actually install a program on their computer, with all the attendant risks of compatibilities with increasingly complex operating systems and hardware drivers

furthermore the devices that do not require the installation of a package on the user's computer require the user to give full control of their computer to some unknown “Big Brother” who may be anywhere, and once this control is given, the data on the user's machine becomes transparent to the administrator of the server on which the viewing application resides. This transparency is for reading as well as writing of information, leading to extremely grave doubts as to the safety and integrity of information residing on machines that do give control to the application residing on a remote server.

All applications/programs, that have been proposed, have a major drawback in that either the user has to download the package and install it to use it (after resetting the machine) thus increasingly running the risk of downloading a potentially malicious and dangerous virus or severe compatibility problems with the current configuration on their computer, or that the user has to give full control, for reading from and writing to, of all the resources of the users computer including hard disk drives and printers, to the code residing on the server, which brings up the possibility of grave misuse, such as deletion of files, formatting of hard disks, exposure of confidential files.

VectorEyes—how to make and how use it

VectorEyes is created by a combination of coded instructions written in various languages like JAVA, HTML, XML, Visual Basic Script, J Script or any other which may be required depending on user requirements from time to time during the process as and when the need arises.

Creating a table of properties starts the process of making it.

The table of properties is the requisite plan for creating the product and consists of all the envisaged functions of the product.

Each property is carefully examined and broken down into component sub-properties.

Each sub-property is a sub-module.

The language is chosen to write the sub-modules.

The Java version chosen is of the lowest common denominator to enable it to run on all operating systems and browsers

The sub-modules are carefully coded as per the syntax of the language. Each sub-module is tested to see that there are no problems in the working. The sub-modules are assembled together to create the modules.

Java Objects called classes are created to represent each and every individual property including reading the file from the server, transferring it to the Random Access Memory and manipulating the Random Access Memory to zoom, pan, search among other functions.

Each class is equivalent to a module.

These classes are then compiled to enable them to run on any machine regardless of processor or operating system, as long as the machine is capable of running a Java Virtual machine.

1. VectorEyes resides on the server.

2. VectorEyes authenticates the user and give restricted access-rights to the user based on the user name and password entered by the user.

3. VectorEyes lets the user perform following tasks from a remote machine connected to the server by means of any type of Network, wired, wireless, or dialup connection.

4. VectorEyes allows the user to administer the site which includes giving permissions, creating users and log-ins etc

5. VectorEyes allows the user to add the drawings, documents, spreadsheets scanned images or any other data in any different format (collectively referred as “data” in subsequent sections), which will be supported by VectorEyes depending on the user specification and changing technology.

6. VectorEyes will allow user to view the data from a remote machine

7. VectorEyes will allow user to edit the data, redline the data and print the data.

8. The viewing of the data will be supported by advanced viewing tools like dynamic-zooming (enlargement or reduction of the view on the display device), searching, zooming to window and zooming to any view by keying-in any search criteria. Panning (shifting the view in any direction to view the area not covered in the current display area), resetting the view to see the full content of the data. Any other tool, which may not be covered in the text above but is specified by the user as requirement for the product.

9. VectorEyes will allow the user to print the data from the client machine on the printer attached on client machine or on a Network accessible to the client machine at full resolution and on any paper size supported by the printer. The printing utility may be tracked, billed, or indexed based on the user requirements.

10. VectorEyes will also allow the user to save the data on their local machine (client-side) and save or email the redlining done by the user depending on the permission granted by the administrator of the site.

11. VectorEyes will allow the user to super impose different types of data and formats on a single display device, which is popularly known as “Layering”.

12. VectorEyes will allow changing and controlling the colors of each layer, entity or background of the data in order to customize the display according to personal choice.

13. VectorEyes will also support “Hidden-Data-attachment” to the displayed data which can be viewed, edited, printed or queried by the user to filter, select or view extended information about any data element.

14. VectorEyes will support data analysis, sorting, and SQL query tools to filter the data, modify the data or create new data using the existing data.

15. VectorEyes will allow the user to link any data to any other URL, any other data file or any other network location.

VectorEyes—system

In order to achieve all or part of above described functionality the VectorEyes inventors have decided to follow a system which is fully and completely original in nature and has been evolved as a result of independent research and development efforts of the inventors. The system they follow is described below.

1. The authentication of user will be performed using independent authentication code or using the existing authentication methods of the customer or using any technology existing during the time of implementation of the program including “finger-print” verification, Password verification, electronic signature verification, voice recognition verification or any other tools or methods required for the purpose of authenticating the user.

2. In order to handle the data of different format VectorEyes may adopt one or more methods in isolation or combination described below:

a. Converting the data to any other format including but not limited to formats invented by them for specific purpose or to any of the formats prevailing in the market, which are supported by other software applications in the market.

b. Directly reading the data files created by any other software application in their proprietary format without any conversion or any modification

c. Filtering the selected data and modifying, altering or reducing the contents of the file in order to facilitate the viewing, editing, transferring of the data or facilitating any other functionality of VectorEyes

d. Rewriting, creating or modifying any file format of user's choice in order save the user's modifications back to the server.

e. Supporting a data format specifically designed for VectorEyes by the inventor and which also form the part of VectorEyes's original invention.

3. VectorEyes will use various graphic algorithms in order to facilitate the display of graphic and non-graphic data in efficient and faster way. All such algorithms will be part of original invention. This includes the algorithm to analyze, decode, scale, transform, rotate or process the data for all the functionality explained in the previous section.

4. VectorEyes will use graphical user interface in order to increase the user-friendliness of the application such user interface and capacity to customize the user interface will also be part of the invention.

5. VectorEyes will use a distinctly different algorithm for printing in order to allow the user to print high-resolution printing on client's machine, which is conventionally not available on Web-based utilities. The algorithm will allow the user to print high-resolution images and data on local printer in any size, which the printer supports, without any additional program installation other then the normal web-browser.

6. VectorEyes will use the different types of protocol to connect, display and transfer the data depending on the connecting device, be it a mobile phone, or Palm top or any device which can connect and access the server. Although some of the protocols exist in the computer industry, its specific application and combination of such protocols is part of VectorEyes and form the part of invention.

VectorEyes—Objects and Advantages

Accordingly, several objects and advantages of the present invention are:

(a) To provide a device by which text documents stored at a central location can be viewed by a remote user.

(b) To provide a device by which text documents stored at a central location can be modified by a remote user.

(c) To provide a device by which a remote user can view spreadsheets stored at a central location.

(d) To provide a device by a remote user can modify which spreadsheets stored at a central location.

(e) To provide a viewing device by a remote user can view which drawings in any known format stored at a central location.

(f) To provide a device by a remote user can modify which drawings stored at a central location.

(g) To incorporate all the above facilities in one device for ease of usage

(h) To provide all the advantages listed a-g, without the user having to download any computer program.

(i) To provide those advantages with the user only needing an Internet connection and any Internet browser, that is no additional computer program or application or plug-in.

(j) To provide those advantages on any platform and operating system, that is, no dependencies on any single operating system/platform.

(k) To provide all those advantages seamlessly from the users perspective, within the browser, with no risk of viruses, configuration incompatibilities, or loss of local user control.

We claim

1. A computer software program system, unless otherwise mentioned, comprising software components, hardware components, software modules, support programs, collaborative objects, databases, Images, visual user interfaces, human user interfaces, help systems, that make the software system operational and functional; the said computer software program system being used to load, display, and mutate all types of computer digital file formats including but not limited to all raster, vector, text, binary, hex, octal file formats.

2. One of the software components of claim 1 comprising class Bargauge wherein it extends Component implements ProgressShower

3. One of the software components of claim 1 comprising class Counter

4. One of the software components of claim 1 comprising class CountinginputStream wherein it extends InputStream

5. One of the software components of claim 1 comprising class DedicatedVFFFilelnputStream

6. One of the software components of claim 1 comprising class VFFStreamReader

7. One of the software components of claim 1 comprising class AsciiVFFStreamReader wherein it extends VFFStreamReader

8. One of the software components of claim 1 comprising class BinaryVFFStreamReader wherein it extends VFFStreamReader

9. One of the software components of claim 1 comprising class VFF3DFACE wherein it extends VFFSOLID

10. One of the software components of claim 1 comprising class VFFARC wherein it extends VFFCIRCLE

11. One of the software components of claim 1 comprising class VFFATTDEF wherein it extends VFFEntity

12. One of the software components of claim 1 comprising class VFFBinaryFormatException wherein it extends Exception

13. One of the software components of claim 1 comprising class VFFBLOCK wherein it extends VFFEntity implements VFFEntityCollector

14. One of the software components of claim 1 comprising class VFFBlocks wherein it extends VFFSection

15. One of the software components of claim 1 comprising class VFFCIRCLE wherein it extends VFFEntity

16. One of the software components of claim 1 comprising class VFFColorModel implements VFFColors

17. One of the software components of claim 1 comprising class VFFDIMENSION wherein it extends VFFEntity

18. One of the software components of claim 1 comprising class VFFENDBLK wherein it extends VFFEntity

19. One of the software components of claim 1 comprising class VFFENDSEC wherein it extends VFFEntity

20. One of the software components of claim 1 comprising class VFFENDTAB wherein it extends VFFTable

21. One of the software components of claim 1 comprising class VFFEntities wherein it extends VFFSection implements VFFConvertable

22. One of the software components of claim 1 comprising class VFFEntity implements VFFlnterface, VFFConvertable

23. One of the software components of claim 1 comprising class VFFEntityCounter

24. One of the software components of claim 1 comprising class VFFEntitySet implements VFFConvertable, VFFEntityCollector

25. One of the software components of claim 1 comprising class VFFException wherein it extends ResourcedException

26. One of the software components of claim 1 comprising class VFFFile implements VFFReporter

27. One of the software components of claim 1 comprising class VFFFile implements VFFReporter

28. One of the software components of claim 1 comprising class VFFFont

29. One of the software components of claim 1 comprising class VFFFontFromStream wherein it extends VFFFont

30. One of the software components of claim 1 comprising class VFFGroups

31. One of the software components of claim 1 comprising class VFFHeader wherein it extends VFFSection

32. One of the software components of claim 1 comprising class VFFINSERT wherein it extends VFFEntity

33. One of the software components of claim 1 comprising class VFFLAYER wherein it extends VFFTable

34. One of the software components of claim 1 comprising class VFFLINE wherein it extends VFFEntity

35. One of the software components of claim 1 comprising class VFFPOINT wherein it extends VFFEntity

36. One of the software components of claim 1 comprising class VFFPOLYLINE wherein it extends VFFEntity implements VFFEntityCollector

37. One of the software components of claim 1 comprising class VFFSection

38. One of the software components of claim 1 comprising class VFFSEQEND wherein it extends VFFEntity

39. One of the software components of claim 1 comprising class VFFSOLID wherein it extends VFFEntity

40. One of the software components of claim 1 comprising class VFFSTYLE wherein it extends VFFTable

41. One of the software components of claim 1 comprising class VFFTable implements VFFlnterface

42. One of the software components of claim 1 comprising class VFFTables wherein it extends VFFSection implements VFFTableCollector

43. One of the software components of claim 1 comprising class VFFTEXT wherein it extends VFFEntity

44. One of the software components of claim 1 comprising class VFFTRACE wherein it extends VFFSOLID

45. One of the software components of claim 1 comprising class VFFUnsupportedException wherein it extends VFFException

46. One of the software components of claim 1 comprising class VFFVectorEyesRTEX wherein it extends VFFEntity

47. One of the software components of claim 1 comprising class ErrorBox wherein it extends InfoBox implements OkListener

48. One of the software components of claim 1 comprising class FramedArea wherein it extends RPanel

49. One of the software components of claim 1 comprising class ImageBox wherein it extends Dialog implements OkListener

50. One of the software components of claim 1 comprising class ImageCanvas wherein it extends Canvas

51. One of the software components of claim 1 comprising class InfoBox wherein it extends Dialog implements OkListener

52. One of the software components of claim 1 comprising class lnsetPanel wherein it extends Panel

53. One of the software components of claim 1 comprising class LayerList wherein it extends java.awt.List implements ItemListener

54. One of the software components of claim 1 comprising class LowerArea wherein it extends RPanel

55. One of the software components of claim 1 comprising class MultiLineLabel wherein it extends Panel

56. One of the software components of claim 1 comprising class OkAdapter implements ActionListener

57. One of the software components of claim 1 comprising class Point3D

58. One of the software components of claim 1 comprising class RButton wherein it extends Button implements Localizable

59. One of the software components of claim 1 comprising class RCheckboxMenuItem wherein it extends CheckboxMenuItem implements Localizable

60. One of the software components of claim 1 comprising class RChoice wherein it extends Choice implements Localizable

61. One of the software components of claim 1 comprising class rescomp

62. One of the software components of claim 1 comprising class ResourceBundleCollection wherein it extends ResourceBundle

63. One of the software components of claim 1 comprising class ResourcedException wherein it extends Exception

64. One of the software components of claim 1 comprising class RFrame wherein it extends Frame implements Localizable

65. One of the software components of claim 1 comprising class RLabel wherein it extends Label implements Localizable

66. One of the software components of claim 1 comprising class RMenu wherein it extends Menu implements Localizable

67. One of the software components of claim 1 comprising class RMenuBar wherein it extends MenuBar implements Localizable

68. One of the software components of claim 1 comprising class RMenultem wherein it extends Menultem implements Localizable

69. One of the software components of claim 1 comprising class RPanel wherein it extends Panel implements Localizable

70. One of the software components of claim 1 comprising class SplashScreen implements Runnable

71. One of the software components of claim 1 comprising class SplashWindow wherein it extends Window

72. One of the software components of claim 1 comprising class TextBox wherein it extends Dialog implements OkListener

73. One of the software components of claim 1 comprising class TrafoTest

74. One of the software components of claim 1 comprising class UpperArea wherein it extends RPanel

75. One of the software components of claim 1 comprising class Utility

76. One of the software components of claim 1 comprising class ZLabel wherein it extends Label implements Localizable

77. One of the software components of claim 1 comprising class ZWindow wherein it extends Window implements Localizable

78. One of the software components of claim 1 comprising class Rframe wherein it extends BasicFrame implements Localizable

79. One of the software components of claim 1 comprising class PCutPan wherein it extends CutPan implements Localizable

80. One of the software components of claim 1 comprising class SLZoom wherein it extends Zoom implements Localizable

81. One of the software components of claim 1 comprising class MScreen implements MScreen

82. One of the software components of claim 1 comprising class Layerinfo wherein it extends Layerlist

83. One of the software components of claim 1 comprising class HTConnect wherein it extends HTMparser implements HTMListener

84. One of the software components of claim 1 comprising class Circle

85. One of the software components of claim 1 comprising class FrameSupport wherein it extends Frame

86. One of the software components of claim 1 comprising class Line

87. One of the software components of claim 1 comprising class Save

88. One of the software components of claim 1 comprising class Open

89. One of the software components of claim 1 comprising class RMlSupport

90. One of the software components of claim 1 comprising class RMlDbase

91. One of the software components of claim 1 comprising class ASPLook

92. One of the software components of claim 1 comprising class ASPWrite

93. One of the software components of claim 1 comprising class JScriptRead

94. One of the software components of claim 1 comprising class JScriptdecode

95. One of the software components of claim 1 comprising class ASPWrite

96. One of the software components of claim 1 comprising class ASPSubmit

97. One of the software components of claim 1 comprising class Residentify

98. One of the software components of claim 1 comprising class Screencaic
